(19) United States
(12) Patent Application Publication
(10) Pub. No.: US 2011/0125463 A1
(43) Pub. Date: May 26, 2011

(54) METHOD FOR REPRESENTING A STATE

(75) Inventors: Hans-Willi Kessler, Langerwehe (DE); Klaus Vaehsen, Duesseldorf (DE); Jens Wellhausen, Aachen (DE)

(73) Assignee: SCHAEFFLER TECHNOLOGIES GMBH & CO. KG, Herzogenaurach (DE)

(21) Appl. No.: 13/054,125

(22) PCT Filed: Jun. 26, 2009
(86) PCT No.: PCT/DE2009/000887

§ 371 Date: Jan. 14, 2011

(30) Foreign Application Priority Data
Jul. 16, 2008 (DE) 10 2008 033 500.2

(51) Int. Cl. G06F 15/00

(52) U.S. Cl. 702/189

(57) ABSTRACT

A method for representing a state of at least one component of an apparatus, where measurements are conducted for the at least one component, a number of quantities are measured and at least one acquired characteristic value for the number of quantities is represented in at least one two-dimensional coordinate system for representing the state as a vector. Further, a system for representing a state of at least one component of an apparatus, to a computer program, and to a computer program product is disclosed.

### FIELD OF THE INVENTION

The invention relates to a method for representing a state of at least one component of an apparatus, to an arrangement for representing a state of at least one component of an apparatus, to a computer program and to a computer program product.

### BACKGROUND OF THE INVENTION

The assessment of the state of apparatuses, for example machines or installations, is usually based on analyzing the temporal development of different variables, that is to say measurement or characteristic variables. This also includes trending and thus the provision of trends or a tendential development of individual variables, different parameters being represented in multidimensional form on the basis of time or other relevant characteristic variables.

The problem of representing a multiplicity of different characteristic variables, which are based on the oscillation signal in the time or frequency range for example, in a clear form arises, inter alia, in the field of machine diagnosis. An associated difficulty is that it has hitherto not been possible to reliably make a statement on the overall state of the machine or installation at a glance since a characteristic value measured for a characteristic variable is designed for different subassemblies of the machine or installation or else is so inaccurate for general diagnosis that monitoring of individual characteristic values is not reliable enough.

### SUMMARY OF THE INVENTION

The invention relates to a method for representing a state of at least one component of an apparatus. In this case, provision is made for measurements to be carried out for the at least one component, a number of variables being measured and at least one recorded characteristic value for the number of variables being represented as a vector in an at least two-dimensional coordinate system for representing the state.

The method is usually carried out in such a manner that there is a relationship between the state, the at least one characteristic value and the vector. The at least one characteristic value is recorded or determined during at least one measurement of the number of variables, a statement on the state being made by this at least one characteristic value. The vector which can also be referred to as an event vector is provided for the purpose of illustrating the state in the at least two-dimensional diagram, this vector corresponding to a depiction of the at least one characteristic value and thus of the state. A machine component state, a machine state or an installation state can be represented as the state, for example.

A vector used to represent a state has a number of dimensions, which number is adapted to the application. Alternatively or additionally, the dimension of the vector can also depend on a diagram used to represent the state. As a result of the selected number of dimensions, a corresponding number of parameters can be represented by the vector. Vectors are usually represented as two-dimensional arrows, for example. However, provision may be made within the scope of the invention for vectors to generally be graphical elements.

In a refinement, measurements are carried out for the at least one component in a region of raw signals and envelope curve signals. Unfiltered raw signals and/or filtered time and frequency signals or time and frequency signals preprocessed in another manner, for example envelope curve signals in the sense of the signal demodulation which is conventional in the field of oscillation diagnosis, may be processed for the at least one component. On the basis of this, the at least two-dimensional coordinate system is spanned in the region of the raw signals and envelope curve signals. The raw signals are typically provided from unfiltered oscillation signals and the envelope curve signals are provided from demodulated oscillation signals.

Within the scope of the method, characteristic values or values for at least one subassembly of the apparatus, which comprises the at least one component of the apparatus, are provided by the vectors. In this case, the values can be determined by measuring oscillation or sound, for example. Values for temperature measurements, oil state measurements and other measurements can also generally be determined.

In addition, a resultant vector, for example a time-dependent vector, can be calculated for at least one measurement from at least one by the provided characteristic value which represents the state, a state of the at least one component of the apparatus at a time tₙ, being represented by this resultant vector.

One variant of the method provides for a respective vector in the at least two-dimensional coordinate system to be defined via an angle and a length, the angle and the length representing oscillations in the form of shocks and/or sinusoidal oscillations. In addition, a respective vector is assigned to a quadrant and/or cuboid of the at least two-dimensional coordinate system.

Depending on the refinement, the vector which represents a characteristic value may be represented as time-dependent or frequency-dependent.

The invention also relates to an arrangement for representing a state of at least one component of an apparatus. The arrangement has at least one measuring module which is designed to carry out measurements for a component and, in the process, to measure a number of variables or at least one variable. The arrangement also has at least one display module which is designed to represent at least one recorded characteristic value for the number of variables for representing the state as a vector in an at least two-dimensional coordinate system.

The arrangement may have, inter alia, at least one computation unit which is designed to provide the at least one vector for representing the state in the at least dimensional coordinate system.

The described arrangement is designed to carry out all of the steps of the presented method. In this case, individual steps of this method may also be carried out by individual modules of the arrangement. Furthermore, functions of the arrangement or functions of individual modules of the arrangement may be implemented as steps of the method.

The invention also relates to a computer program having program code means for carrying out all of the steps of a described method when the computer program is executed on a computer or a corresponding computation unit, in particular in an arrangement according to the invention.

The computer program product according to the invention having program code means which are stored on a computer-readable data storage medium is designed to carry out all of the steps of a described method when the computer program is executed on a computer or a corresponding computation unit, in particular in an arrangement according to the invention.

The method is suitable, inter alia, for simply and clearly representing damage states in apparatuses in the form of machines or installations. In one variant, general measurement data evaluation and representation, for example of state measurements on rolling bearings, sliding bearings and/or tooth systems by means of oscillation analysis, are thus possible.

The method can typically be used to provide a clear representation of a multiplicity of variables on the basis of recorded characteristic values for simply detecting the state of complex apparatuses, for example complex systems such as gear mechanisms, rolling mills, etc.

The invention introduces an at least two-dimensional coordinate system which is usually spanned by measurements in the raw signal and envelope curve signal regions. The dependence of these two signal forms on the state of the apparatus is used in this case.

The described method generally makes it possible, for example, to assess and/or diagnose a state of the apparatus, which may be in the form of a machine or installation, using oscillation or sound measurements, for example structure-borne noise measurements or air-borne noise measurements, in any desired frequency ranges on the apparatus and to evaluate said measurements in the time and/or frequency range. One aspect of the invention involves plotting event vectors in a two-dimensional, three-dimensional or multidimensional coordinate system. The vectors for individual characteristic values are assigned to different quadrants and/or cuboids of the coordinate system or axis system.

Further advantages and refinements of the invention emerge from the description and the accompanying drawing.

It goes without saying that the abovementioned features and the features still to be explained below can be used not only in the respectively specified combination but also in other combinations or alone without departing from the scope of the present invention.

### BRIEF DESCRIPTION OF THE DRAWINGS

FIG. 1 shows a first exemplary embodiment of a diagram which is in the form of a two-dimensional coordinate system in this case.

FIGS. 2 to 5 each show a second exemplary embodiment of a diagram which is in the form of a two-dimensional coordinate system in this case, different vectors being represented in this diagram for each figure.

FIG. 6 shows a third exemplary embodiment of a diagram which is in the form of a three-dimensional coordinate system in this case.

FIG. 7 shows a fourth exemplary embodiment of a diagram which is in the form of a three-dimensional coordinate system in this case.

FIG. 8 shows an exemplary embodiment of an arrangement according to the invention.

### DETAILED DESCRIPTION OF THE DRAWINGS

The invention is schematically illustrated in the drawings using embodiments and is described in detail below with reference to the drawings.

The figures are described in a coherent and comprehensive manner; the same reference symbols denote the same objects.

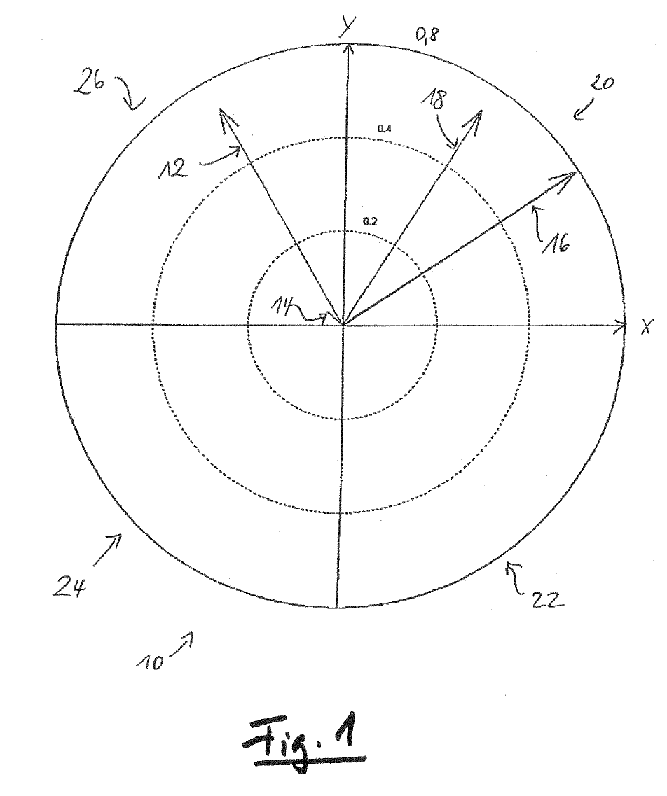

The Diagram 10 in the form of a two-dimensional coordinate system in FIG. 1 has an x-axis and a y-axis. Three vectors 12, 14, 16 are represented in the Diagram 10. The Diagram 10 also has a sum vector 18. The diagram comprises four quadrants 20, 22, 24, 26. In this case, a first quadrant 20 comprises narrowband root mean square (RMS) variables in the form of diagnosis variables, and a second quadrant 22 comprises broadband diagnosis variables or root mean square (RMS) variables. A third quadrant 24 comprises envelope broadband diagnosis variables and thus variables, and a fourth quadrant 26 comprises envelope curve signals or envelope narrowband diagnosis variables or variables.

In order to represent a state of at least one component of an apparatus, a refinement of the method provides for a measurement to be carried out for this at least one component. A number of variables are measured for this purpose. At least one value in the form of a characteristic values is represented for this number of variables as a vector 12, 14, 16 in the at least two-dimensional Diagram 10 which is presented here and is intended to represent the state. All of the vectors 12, 14, 16 represented in Diagram 10 as FIG. 1 as well as the sum vector 18 are drawn starting from an origin of the Diagram 10. The embodiment of the method presented using this Diagram 10 provides for a damage profile to be represented as the state of the at least one component.

Vectors 12, 14, 16 in the form of event vectors, for example, are thus diagrammatically illustrated in the two-dimensional state space in the Diagram 10 from FIG. 1. Lengths and angles of the vectors 12, 14, 16 show the significance of a damage profile to the at least one component.

The described method makes it possible to assess and/or diagnose a state of an apparatus, which may be in the form of a machine or installation, using structure-borne noise measurements on the apparatus and to evaluate said measurements in the time and frequency ranges. One aspect of the invention involves plotting vectors 12, 14, 16 and thus event vectors in a two-dimensional, three-dimensional or multidimensional coordinate system or axis system, as illustrated using Diagram 10 from FIG. 1, for example. The individual vectors 12, 14, 16 which represent characteristic values are assigned to the quadrants 20, 22, 24, 26 of Diagram 10.

The position of the vectors 12, 14, 16 is determined by the at least one angle and the length. The assignment of the vectors to the quadrants 20, 22, 24, 26, the length of the vectors 12, 14, 16 and the position of the latter in the vector space is arbitrary in principle.

In the case of apparatus or machine diagnostics, knowledge of damage theory, inter alia, is important when oscillations in the form of shocks and sinusoidal oscillations occur. This defines both the length and the at least one angle of the vectors 12, 14, 16 in Diagram 10 or in the coordinate system in relation to the other variables provided for. In this case, the length of a vector 12, 14, 16 can directly represent the measured value or a variable derived from the measured value or else may be determined by standardization to any desired values, for example a starting value of a measurement.

In this special case, Diagram 10 in the form of a coordinate system or axis system distinguishes, on the one hand, measurements in the raw signal region, in which case unfiltered oscillation signals are taken into account. On the other hand, a distinction from envelope curve signal measurements is also provided, in which case demodulated signals are taken into account. In the example, the x-axis represents this classification. The yyaxis perpendicular to the xxaxis evolves from broadband diagnosis variables to narrowband diagnosis variables. This is thus a representation based on the frequency range.

In another variant, any desired third dimension is conceivable, for example the z-axis as a power axis or time axis. Any desired fourth dimension can be inserted by suitable coloring, for example. The representation of a fifth dimension is likewise possible if the vectors are depicted with different line thicknesses.

For each measurement, it is thus possible to span a vector field comprising different vectors 12, 14, 16 which are ultimately calculated to form a resultant vector, here the sum vector 18. This resultant vector or sum vector 18 represents the state of the machine at a first time t₁. Unambiguous vectors 12, 14, 16 can be accordingly defined for different times tₙ. This results in the end points of these vectors 12, 14, 16 being arranged in a limited region of the vector space inside Diagram 10. If the state of the apparatus or machine changes, the vectors 12, 14, 16 migrate to a different quadrant 20, 22, 24, 26 inside Diagram 20. This provides an immediate overview of whether or not the state of the at least one component and thus of the apparatus or machine changes. The at least one characteristic value and the subassembly which comprises at least one component of the apparatus can then be immediately identified using a suitable software-supported link.

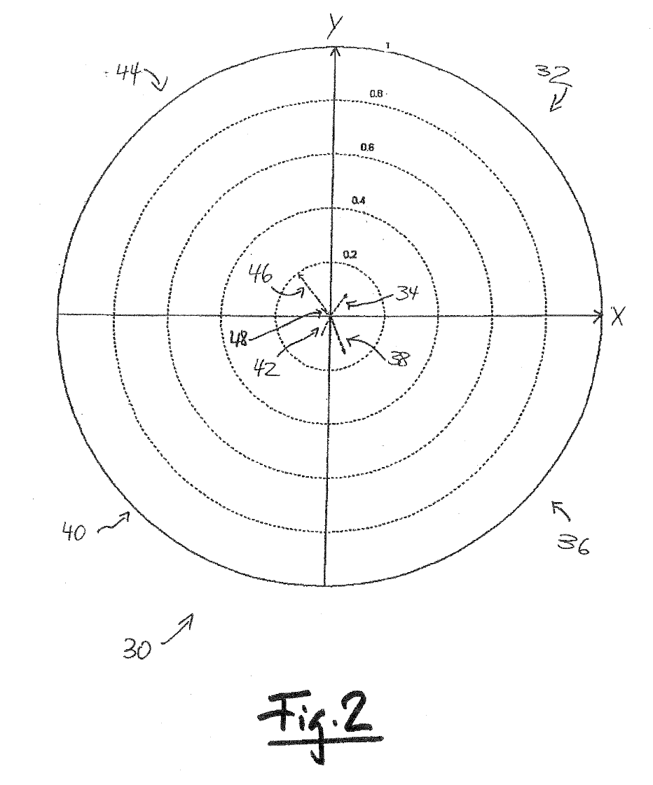

FIGS. 2, 3, 4 and 5 each illustrate a second embodiment of a diagram 30 in the form of a two-dimensional coordinate system. In this case, a first vector 34 is represented in a first quadrant 32 of Diagram 30, a second vector 38 is represented in a second quadrant 36, a third vector 42 is represented in a third quadrant 40 and a fourth vector 46 is represented in a fourth quadrant 44. A resultant vector 48 is also represented in this second embodiment of Diagram 30. In this case, the first quadrant 32 comprises root mean square (RMS) variables which are in the form of narrowband diagnosis variables, and the second quadrant 36 comprises broadband diagnosis variables and thus root mean square (RMS) variables. The third quadrant 40 comprises envelope broadband variables in the form of diagnosis variables and the fourth quadrant 44 is for envelope curve signals or for envelope narrowband diagnosis variables or variables.

This exemplary embodiment also provides for the vectors 34, 38, 42, 46 represented in Diagram 30 to in turn represent at least one characteristic value for a number of variables. The at least one characteristic value is recorded when measuring a state of at least one component of an apparatus. Provision is thus made overall for the vectors 34, 38, 42, 46 shown to illustrate and thus represent the state of the at least one component of the apparatus.

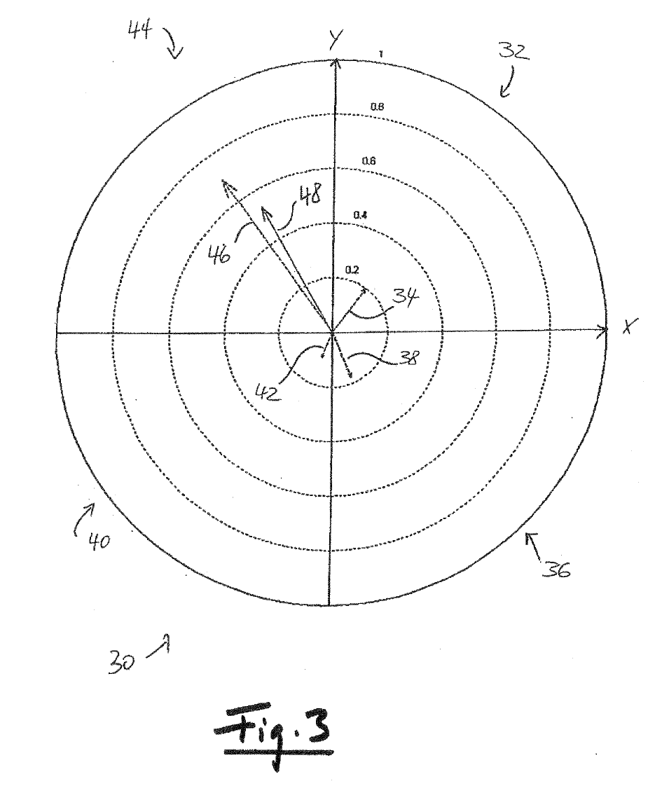

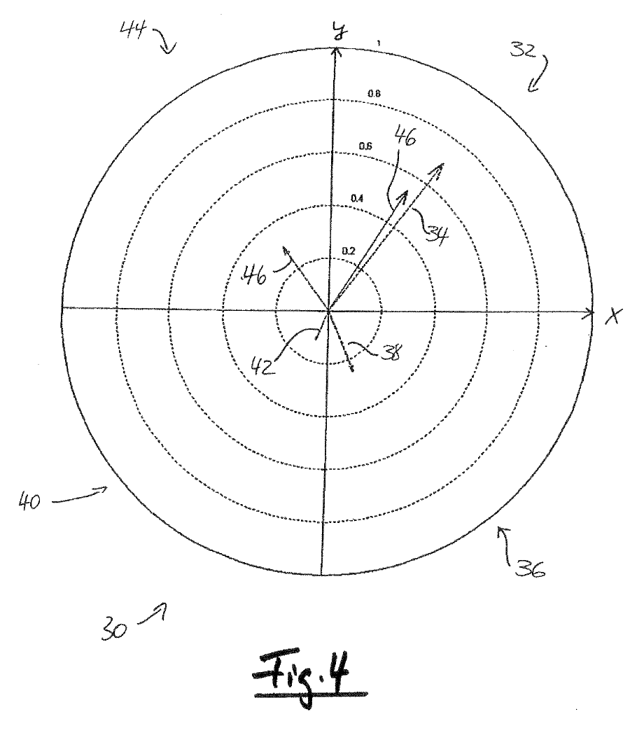

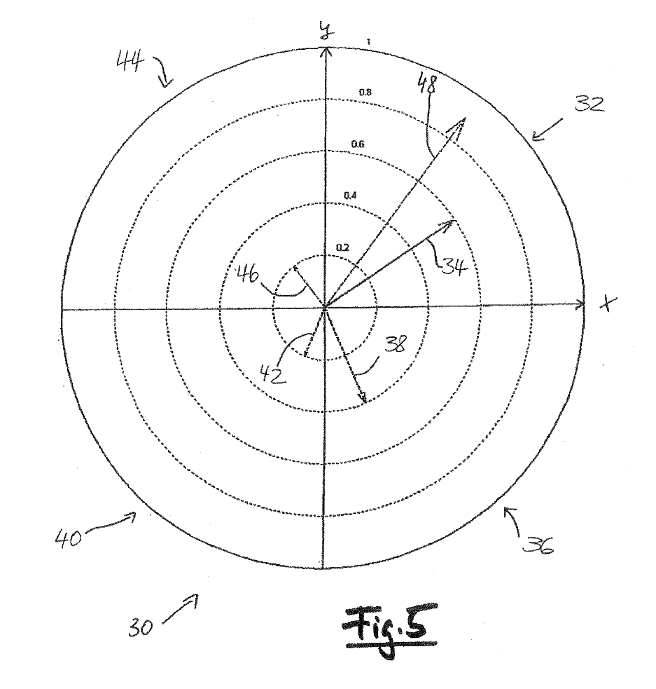

The four FIGS. 2 to 5 show the vectors 34, 38, 42, 46 and the resultant vector 48 at different times. These vectors 34, 38, 42, 46 are simultaneously used to represent a temporal development of four characteristic values. In this case, a first time for a state of the at least one component of the apparatus is illustrated and thus represented by the vectors 34, 38, 42, 46, 48 using the first representation of Diagram 30 in FIG. 2, a second time for a state of the at least one component of the apparatus is illustrated and thus represented by the vectors 34, 38, 42, 46, 48 using the second representation of Diagram 30 in FIG. 3, a third time for a state of the at least one component of the apparatus is illustrated and thus represented by the vectors 34, 38, 42, 46, 48 using the third representation of Diagram 30 in FIG. 4 and a fifth time for a state of the at least one component of the apparatus is illustrated and thus represented by the vectors 34, 38, 42, 46, 48 using the fourth representation of Diagram 30 in FIG. 5.

With a comparative consideration of the four FIGS. 2, 3, 4, 5, it can be seen that the four vectors 34, 36, 42, 46 always point in the same direction, starting from an origin of Diagram 30, and thus have the same angle for all of said times. A change in the state of the at least one component on the basis of time is reflected in FIGS. 2, 3, 4, 5 by different lengths of the vectors 34, 38, 42, 46. The resultant vector 48 is calculated from the four vectors 34, 38, 42, 46, for example by vector addition, and therefore has different angles or directions and different lengths for all four times.

In Diagram 30 from FIG. 2, the vectors 34, 38, 42, 46 schematically represent a so-called good state. The magnitude of the individual characteristic values represented by the vectors 34, 38, 42, 46 is small. The resultant vector 48 shows in a narrowband envelope curve signal region with a likewise small magnitude.

An increase of a characteristic of the fourth vector 46, as is theoretically the case when damage to the outer ring of a rolling bearing begins, is shown in the region of the narrowband envelope curve signal analysis in Diagram 30 from FIG. 3. The remaining vectors 34, 38, 42 do not show a significant change. The magnitude of the resultant vector 48 is greater than in FIG. 2 and thus, in conjunction with the change in angle, clearly shows developing damage.

Progressive development of damage, as schematically illustrated in Diagram 30 from FIG. 4, is characterized by a transition of the resultant vector 48 from the fourth quadrant 44 to the first quadrant 32 and thus from envelope curve signals to RMS raw signal values. The resultant vector 48 thus undergoes a considerable change in angle in this region.

Development of damage which progresses further is illustrated in the diagram from FIG. 5; in this case, the contribution of the broadband characteristic values is increased, which results in further rotation of the sum vector 48.

Another possible way of representing the changing state of an apparatus, which is represented by the four vectors 34, 38, 42, 46, is to plot raw signals of all amplitude values of the individual FFT frequency points and thus frequency points of a fast Fourier transformation above one another in a coordinate system spanned by the x-axis region and to plot envelope curve signals of all amplitude values of the individual FFT frequency points and thus frequency points of a fast Fourier transformation above one another in a coordinate system spanned by the y-axis region. The respective associated amplitude values of the frequency, which are obtained from the raw signal A_{10Hzraw} and from the envelope curve signal A_{10Hzenvelope}, form a vector ZA_{10Hzrawenvelope}. With suitable weighting, all vectors _{A}_{iHzrawenvelope} lead to a resultant vector Vᵣₑₛ₍ₜ₎. This resultant vector Vᵣₑₛ₍ₜ₎ from each measurement is ultimately plotted in the diagram at the respective time.

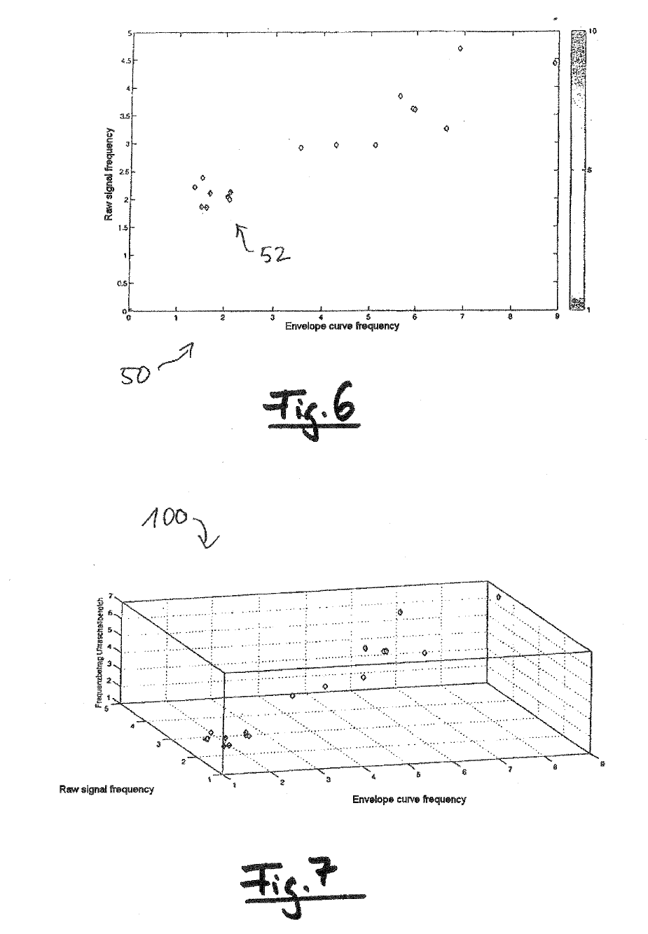

Diagram 50 in the form of a coordinate system from FIG. 6 comprises the schematic representation of such resultant vectors Vᵣₑₛ₍ₜ₎. This diagram is spanned over frequencies for envelope curve signals and raw signals. A changing status of the apparatus is indicated by greatly changed vector positions. In this case, the resultant vectors Vᵣₑₛ₍ₜ₎ are represented as rhombuses inside Diagram 50. In this case, resultant vectors Vᵣₑₛ₍ₜ₎ at a low frequency for a raw signal are first of all measured. Over the course of time, the frequencies of the envelope curve of the resultant vectors Vᵣₑₛ₍ₜ₎ first of all increase, for example, as damage begins to develop. The frequencies of the raw signal additionally increase at later times in the exemplary further development of damage. This makes it possible for the user to visually estimate the development of damage.

Thus, the development of the apparatus or a machine can be directly detected since the frequency spectra in the raw and envelope curve signal regions change on the basis of the state of the machine. This principle is illustrated in FIG. 6. A first cloud 52 with little variance, which is formed from vectors at low frequencies in the region of the envelope curve and in the region of the raw signal, first of all shows a constant state or status of the apparatus. For subsequent measurements, if vectors for increased frequencies which do not belong to this cloud 52 result, they are depicted away from the cloud 52, which clearly indicates a change in the state of the apparatus.

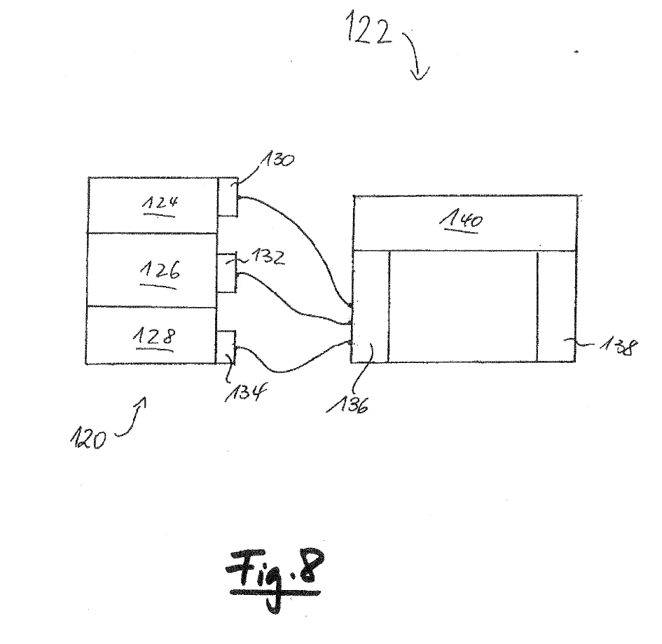

The vectors Vᵣₑₛ₍ₜ₎ from Diagram 50 are likewise represented as rhombuses in three dimensions in Diagram 100 from FIG. 7 in the form of a coordinate system, the frequency in the ultrasound range being taken into account using a third axis.

Additional dimensions, as in the example above, can therefore be introduced in the same way. In this case, it is possible to take into account the ultrasound range up to 1 MHz, for example, as the third dimension. A spatial state assessment can therefore be provided by the additional vector, as shown in Diagram 10 from FIG. 7. However, other physical variables, for example temperature or electrical conductivity, can also be represented along the third dimension.

The combination of ultrasound information with raw or envelope curve signals in the two-dimensional coordinate system or axis system can likewise be implemented within the scope of the method. This results in a representation like that in FIG. 6 with changed axis designations. The procedure described can be created both with time and frequency signals as well as corresponding differences, for example difference spectra.

FIG. 8 schematically illustrates an apparatus 120 and an embodiment of an arrangement 122 according to the invention. In this case, provision is made for the apparatus 120 to have a first component 124, a second component 126 and a third component 128.

In the present embodiment, the arrangement 122 has three measuring modules 130, 132, 134 in the form of sensors. The arrangement 122 also comprises a recording unit 136, a computation unit 138 and display module 140.

In order to implement the method according to the invention, provision is made for a first measuring module 130 to be assigned to a first component 124 of the apparatus 120, for a second measuring module 132 to be assigned to a second component 126 and for a third measuring module 134 to be assigned to a third component 128. The measuring units 130, 132, 134 measure variables of the components 124, 126, 128. In the present embodiment, measured values for the measured variables are transmitted to the recording unit 136 in a wired manner or, alternatively or additionally, in a wireless manner by using suitable radio technology. The computation unit 138 is used to process the measured values for the variables further and to process them to form a graphical representation. The graphically processed characteristic values are displayed, via the display module 140 of the arrangement 122, in the form of Diagrams 10, 30, 50, 100 which are in the form of coordinate systems in this case and have already been presented in FIGS. 1 to 7.

1. A method for representing a state of at least one component of an apparatus, wherein measurements are carried out for the at least one component, a number of variables being measured and at least one characteristic value for the number of variables being represented as a vector in an at least two-dimensional coordinate system for representing the state.

2. The method as claimed in claim 1, wherein unfiltered raw signals and/or filtered time and frequency signals or time and frequency signals preprocessed in another manner are processed for the at least one component.

3. The method as claimed in claim 1, wherein the at least two-dimensional coordinate system is spanned in a region of raw signals and envelope curve signals.

4. The method as claimed in claim 3, wherein the raw signals are provided from unfiltered oscillation signals and the envelope curve signals are provided from demodulated oscillation signals.

5. The method as claimed in claim 1, wherein, for a measurement, a resultant vector is calculated from at least one provided vector, a state of the at least one component at a time being represented by the resultant vector.

6. The method as claimed in claim 1, wherein a respective vector in the at least two-dimensional coordinate system is defined via an angle and a length.

7. The method as claimed in claim 1, wherein a respective vector is assigned to a quadrant of the at least two-dimensional coordinate system.

8. The method as claimed in claim 1, wherein the vectors are time-dependent.

9. The method as claimed in claim 1, wherein the vectors are frequency-dependent.

10. An arrangement for representing a sate of at least one component of an apparatus, wherein the arrangement has at least one measuring module which is designed to carry out measurements for a component and, in a process, to measure a number of variables, and in that the arrangement has at least one display module which is designed to represent at least one recorded characteristic value for the number of variables as a vector in an at least two-dimensional coordinate system for representing the state.

11. The arrangement as claimed in claim 10, wherein the arrangement has at least one computation unit which is designed to provide the at least one vector for representation in the at least two-dimensional coordinate system.

12. A computer program having program code means, wherein the program code means are designed to carry out all of the steps of a method as claimed in claim 1 if the computer program is executed on a computer or a corresponding computation unit in an arrangement as claimed in claim 10.

13. A computer program product, comprising program code means which are stored on a computer-readable data storage medium, wherein these program code means are designed to carry out all of the steps of a method as claimed in claim 1 if the computer program is executed on a computer or a corresponding computation unit in an arrangement as claimed in claim 10.
